(19) United States
(12) Patent Application Publication
(10) Pub. No.: US 2009/0222111 A1
(43) Pub. Date: Sep. 3, 2009

(54) Hot Water Supply Device

(76) Inventors: Shigehiko Matsuoka, Shiga (JP); Kouji Chida, Shiga (JP)

Correspondence Address: BIRCH STEWART KOLASCH & BIRCH, PO BOX 747, FALLS CHURCH, VA, 22040-0747, US

(21) Appl. No.: 11/990,304

(22) PCT Filed: Aug. 4, 2006
(86) PCT No.: PCT/JP2006/315473

§ 371 Date: Feb. 11, 2008

(30) Foreign Application Priority Data
Aug. 12, 2005 (JP) 2005-234591

(51) Int. Cl. G05B 15/00; G05B 19/43

(52) U.S. Cl. 700/78; 700/281

(57) ABSTRACT

A hot water supply device has a host remote controller 27 and a bath remote controller 20 capable of establishing a call with the host remote controller 27. In the normal mode, the call signal of the interphone function is prioritized over the operation signal. The operation signal is transmitted after the call signal ends. An attention calling function to output an attention calling signal during a failure or misuse is provided. The attention calling signal is prioritized over the call signal.

### TECHNICAL FIELD

The present invention relates to a hot water supply device.

### BACKGROUND ART

In a hot water supply device, a remote controller is placed in a bathroom or the like, and operating manipulations of hot water pouring operation to pour some more hot water into the bathtub can be performed by manipulating the remote controller. Lately, there is one such that the remote controller is provided with an interphone function to enable a conversation (call) between a person who is taking a bath and a person in another room and a voice guidance function to give notice of the functioning conditions (operating conditions) of the hot water supply device by a sound (refer to, for example, JP 2004-309062 A). It is herein noted that “rimokon” mentions a remote controller.

The device described in JP 2004-309062 A inhibits the vocalization of the voice guidance for a prescribed time from the stop of the input of a call signal upon ending a call. This eliminates the trouble that, when a call ends partway during a voice guidance signal, the subsequent part of the voice guidance ends within the prescribed time, and the subsequent part of the voice guidance is vocalized later.

However, when a call signal and an operation control signal are concurrently transmitted, a noise is superimposed on the call signal. Therefore, it has been needed to cancel the call signal during the time. If canceled, the call is interrupted during the cancel, and the conversation between the user who is taking a bath and the user in another room is interrupted, which has been inconvenient.

The present invention has been made to solve the above conventional defects, and its object is to provide a hot water supply device capable of stably achieving communications between the user who is taking a bath and the user in another room by a call that is hardly interrupted partway.

### DISCLOSURE OF THE INVENTION

In order to achieve the above object, there is provided a hot water supply device comprising:

a host remote controller having an interphone function section; and

a bath remote controller having an interphone function section capable of establishing a call with the interphone function section of the host remote controller, wherein

a call signal between the interphone function section of the host remote controller and the interphone function section of the bath remote controller is prioritized over an operation signal by switch manipulation of the host remote controller or the bath remote controller in a normal mode, and the operation signal is transmitted after the call signal ends.

In one embodiment of the invention, the host remote controller or the bath remote controller has an attention calling function section that outputs an attention calling signal during a failure, and

the attention calling signal outputted from the attention calling function section is prioritized over the call signal.

In one embodiment of the invention, at least one of the host remote controller and the bath remote controller has an operating condition display function section that displays the operating condition, and,

when the call signal exceeds a prescribed set time, the call signal is stopped and the operating condition is displayed by the operating condition display function section.

In one embodiment of the invention, in the hot water supply device,

while the operation signal is transmitted by the switch manipulation of the host remote controller or the bath remote controller, the interphone function section of the host remote controller and the interphone function section of the bath remote controller stop transmission and reception of the call signal.

According to the hot water supply device of the present invention, the call signal of the interphone function is prioritized over the operation signal of the operating manipulation in the normal mode, and therefore, the call is not interrupted during the call. Therefore, communications between the user taking a bath and the user in another room can stably be achieved. In addition, the operation signal is transmitted when the call ends, so that various operations such as the hot water pouring operation to pour some more hot water into the bathtub can be performed.

There is a hot water supply device, which has a hot water supply unit (tank unit) that has a hot water reservoir tank and a heat pump unit that heats low temperature water in the hot water reservoir tank and sends the water as high temperature water back into the hot water reservoir tank. In such a hot water supply device, it is sometimes the case where the circulation pump fails to cause an anomaly such that the low temperature water cannot be supplied from the hot water reservoir tank to the heat pump unit.

According to the hot water supply device of one embodiment, at the time of the occurrence of an anomaly as described above, the user can be informed of the anomaly by the attention calling function. In addition, the attention calling signal is prioritized over the call signal in the attention calling mode in which the attention calling signal is outputted, and therefore, the user can securely grasp the attention calling state. This can avoid the operation performed still in the anomaly state without perceiving the occurrence of the anomaly that is actually occurring. That is, the operation is not performed in the anomaly state, and the occurrence of the failure of the hot water supply device can be prevented.

Moreover, according to the hot water supply device of one embodiment, which has the operating condition display function to display the operating conditions, the user can therefore grasp the operating conditions. It is herein noted that the operating conditions mean the conditions of the remaining amount of usable high temperature hot water (hot water remaining amount) in the hot water reservoir tank and so on, and the operating conditions include those which the user needs to periodically know. Therefore, the hot water supply device is able to stop the call signal and display the operating conditions when the call signal exceeds the prescribed set time. That is, it is often the case where a conversation continuation state takes place due to an erroneous call signal ascribed to ambient noises or the conversation has contents that are not important when the call signal exceeds the prescribed set time. Therefore, the call is stopped, and the operating conditions that the user needs to know are displayed, improving the usability of the hot water supply device.

Moreover, according to the hot water supply device of one embodiment, the transmission and reception of the call signal can be stopped while the operation signal is transmitted by the switch manipulation of the bath remote controller. That is, it is enabled to transmit the operation signal concerning the operation performed by the switch manipulation of the bath remote controller (signal concerning the operation which is being a command signal for changing the hot water supply temperature, for additionally boiling water to replenish the hot water reservoir tank with high temperature hot water or the like) can be transmitted preferentially over the call signal. This prevents the call signal from interrupting and stopping the operating manipulation while the operation signal is transmitted, so that the operation demanded by the user can reliably be performed.

### BRIEF DESCRIPTION OF THE DRAWINGS

FIG. 1 is a simplified schematic view of a hot water supply device that employs the hot water supply device of the present invention;

FIG. 2 is a simplified schematic view of the hot water supply device; and

FIG. 3 is a flowchart for explaining the functions of the hot water supply device of the present invention.

### DETAILED DESCRIPTION OF THE INVENTION

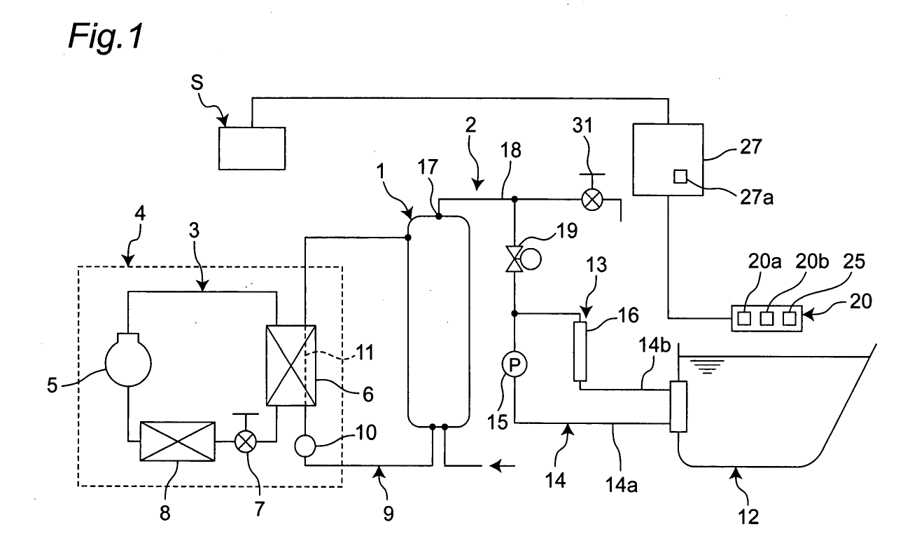

Concrete embodiments of the hot water supply device of the present invention will be described in detail next with reference to the drawings. FIG. 1 is a simplified overall schematic view of the hot water supply device. The hot water supply device is a heat pump type water heater including a tank unit 2 that has a hot water reservoir tank 1, a heat source unit (hereinafter referred to as a heat pump unit) 4 that has a refrigeration cycle 3, a control means S for controlling the tank unit 2 and the heat pump unit 4, a host remote controller 27 placed in a kitchen or the like and a bath remote controller 20 placed in a bathroom and serves to heat the water (warm water) in the hot water reservoir tank 1 by the heat pump unit 2.

The refrigeration cycle 3 is constituted by successively connecting a compressor 5, a water heat exchanger 6, an expansion valve 7 and an evaporator 8. Then, the tank unit 2 has the hot water reservoir tank 1 and a circulation passage 9, and a water circulation pump 10 and a heat exchange passage 11 are provided in the circulation passage 9. In this case, the heat exchange passage 11 is constituted of the water heat exchanger 6.

That is, when the compressor 5 is driven and the pump 10 is driven (operated), the reserved water (warm water) flows to the circulation passage 9 from an water outlet provided at the bottom of the hot water reservoir tank 1, and the water passes through the heat exchange passage 11. At the time, the warm water is heated (boiled) by the water heat exchanger 6 and sent back to an upper portion of the hot water reservoir tank 1 from a hot water inlet. By this operation, hot water of a high temperature is reserved in the hot water reservoir tank 1.

The hot water in the hot water reservoir tank 1 is supplied to a bathtub 12 or the like. Moreover, a temperature keeping circulation passage 13 for keeping the temperature of the hot water in the bathtub 12 is connected to the bathtub 12. The temperature keeping circulation passage 13 is constituted of a circulation piping 14, and a pump 15 and a temperature keeping electric heater 16 that are provided in the circulation piping 14. That is, the circulation piping 14 is constructed of a first piping 14a and a second piping 14b. The pump 15 is provided in the first piping 14a, and the temperature keeping electric heater 16 is provided in the second piping 14b. With this arrangement, by driving the pump 15, the hot water in the bathtub 12 is introduced into the first piping 14a of the circulation piping 14, flows from the first piping 14a into the second piping 14b, is heated by the temperature keeping electric heater 16 and is sent back to the bathtub. Then, by continuing the circulation, the hot water in the bathtub 12 is kept at a roughly constant temperature.

Moreover, the temperature keeping circulation passage 13 is connected to a piping 18 connected to a hot water outlet 17 of the hot water reservoir tank 1. An on-off valve 19 is provided in the piping 18. When the on-off valve 19 is in an open state, the hot water of a high temperature in the hot water reservoir tank 1 is supplied to the bathtub 12 via the piping 18 and the temperature keeping circulation passage 13, supplying hot water into the bathtub 12. When the on-off valve 19 is in a closed state, temperature keeping operation is performed, as described above, by circulating the hot water in the bathtub 12 through the temperature keeping circulation passage 13.

Then, in the bathroom in which the bathtub 12 is placed, the bath remote controller 20 is provided on its wall surface. The bath remote controller 20 has an operating function to carry out various operation manipulations and a call function (interphone function). In this case, the interphone function enables conversations between the bath remote controller 20 and the host remote controller 27.

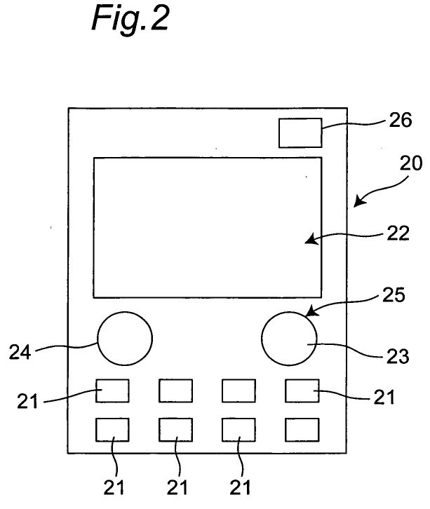

As shown in FIG. 2, the remote controller 20 includes a plurality of manipulating buttons 21, . . . that command various operations, a monitor screen 22, and a call function constituting section 25 as one example of the interphone function section that has a voice generating part (speaker part) 23 and a voice transmitting part (microphone part) 24. It is noted that the numeral 26 in FIG. 2 denotes a power switch.

Moreover, the bath remote controller 20 is connected to the host remote controller 27. Although not illustrated, the host remote controller 27 is provided with a call function constituting section 27a as one example of the interphone function section that has a voice generating part (speaker part) and a voice transmitting part (microphone part) as in the bath remote controller 20.

With this arrangement, when a user inputs a voice to the voice transmitting part 24 of the call function constituting section 25 at the bath remote controller 20, the call signal is transmitted from the voice transmitting part 24 to the host remote controller 27. Then, a voice is generated by the voice generating part of the host remote controller 27 based on the call signal. Conversely, when a user inputs a voice to the voice transmitting part of the host remote controller 27, the call signal is transmitted from the voice transmitting part to the bath remote controller 20. Then, a voice is generated by the voice generating part of the bath remote controller 20 based on the call signal. As described above, conversations between the bath remote controller 20 and the host remote controller 27 are enabled.

Moreover, the bath remote controller 20 has an attention calling function section 20a for outputting an attention calling signal during a failure or misuse. That is, the attention calling to the failure or misuse of the device is displayed on a monitor screen 22. It is noted that the attention calling signal further includes a hot water supply temperature setting signal when changing the set temperature and so on.

Therefore, the present hot water supply device has an anomaly detection means (means for performing the attention calling function) for detecting the anomaly in the anomaly state of a failure. For example, when an anomaly occurs in the pumps 10, 15 or the like in the circulation system of the hot water, there is a change in the voltage value of the pump motors, and the anomaly detection means detecting the change is adequate. Regarding the heat pump unit 4, there is an operation to control the temperature of the discharge pipe of the compressor 5 for improving the operating efficiency (COP). For this purpose, the temperature of the discharge pipe of the compressor 5 has been detected by a discharge pipe temperature detection means (for example, a temperature thermistor). However, when the discharge pipe temperature detection means is defective, it is sometimes the case where the discharge pipe temperature detection means indicates a temperature lower than the correct temperature of the discharge pipe. As described above, when the detected discharge pipe temperature is lower, the compressor is to be operated at a very high discharge gas temperature, resulting in lowering the reliability of the compressor and COP. That is, an anomaly detection means can be constituted of the discharge pipe temperature detection means.

As described above, when an anomaly occurs, the event is displayed on the monitor screen 22, and the display can be changed in various ways according to the part of anomaly, the kind of the anomaly and so on. For example, it is allowed to indicate the part where the anomaly is occurring by an illust. (illustration) or to display the kind of the anomaly by a sentence, a sign or the like. Moreover, it is acceptable to generate a warning sound (buzzer sound) from a voice generating part 23.

Moreover, the monitor screen 22 is also able to display the operating conditions. That is, the host remote controller 27 and the bath remote controller 20 have an operating condition display function section 20b that displays the operating conditions. It is herein noted that the operating conditions mean information that the user needs to be periodically informed of, such as the conditions of the remaining amount of usable hot water (hot water remaining amount) in the hot water reservoir tank 1 and so on.

In this case, the bath remote controller 20 has storage means (e.g., flash memory), and when the attention calling signal, the operating condition display signal and the like are commanded from the control means S that controls various operations of the additional boiling operation to replenish the hot water reservoir tank 1 with high temperature hot water, hot water temperature keeping operation of the bathtub 12 and so on, those signals are inputted to the host remote controller 27 and the bath remote controller 20. When a signal is inputted, the signal is once stored in the storage means. When the signal is thus stored in the storage means, a signal that indicates the event of the storage is inputted to a control section (microcomputer) of the bath remote controller 20. By this operation, the bath remote controller 20 performs the attention calling function and the operating condition display function.

The attention calling signal and the operating condition display signal are based on the manual manipulation of the switch 30 or an output command from the control means S. That is, the attention calling signal or the like can be outputted by the manual manipulation of the switch 30 or on the basis of the output command from the control means S. The present hot water supply device can operate in a manual mode or an automatic mode. For example, in the manual mode, when the switch is manipulated, the attention calling signal corresponding to the operation or the like is outputted. Moreover, in the automatic mode, when an anomaly state is detected by the anomaly detection means as described above, the voice guidance of “attention calling” indicating the anomaly is outputted by the output command from the control means S without manipulating the switch.

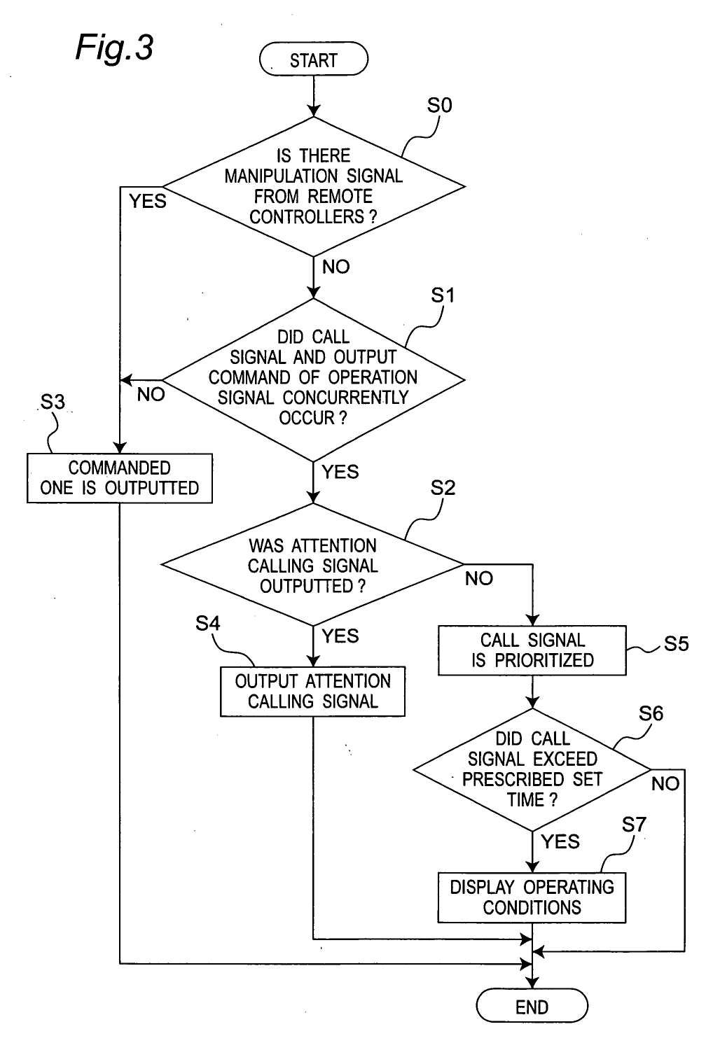

In the hot water supply device constructed as above, it is enabled to issue an operation signal or to issue a call signal by using the bath remote controller 20 provided at the bathroom. That is, it is enabled to perform the functions as shown in the flowchart shown in FIG. 3. The function is described below according to the flowchart.

First of all, in the present hot water supply device, it is determined in step S0 whether or not there is a manipulation signal from the bath remote controller 20 or the host remote controller 27. The program flow proceeds to step S3 when there is a manipulation signal or proceeds to step S1 when there is no manipulation signal. As described above, the operation signal (e.g., a bath setting temperature change signal or a hot water additional pouring command signal) concerning the operation performed by manipulating the switch 21 of the bath remote controller 20 is preferentially transmitted regardless of the presence or absence of the call signal. Next, it is determined in step S1 whether or not the call signal and the output command signal of the operation signal concurrently occur, and the program flow proceeds to step S2 when they concurrently occur or proceeds to step S3 when they do not concurrently occur.

It is determined in step S2 whether or not the attention calling signal has been outputted. The program flow proceeds to step S4 when the attention calling signal is outputted or proceeds to step S5, i.e., the normal mode when the attention calling signal is not outputted. In step S3, commanded one is outputted, e.g., when a call signal is commanded to be outputted, the call signal is outputted and when an operation signal is commanded to be outputted, the operation signal is outputted. It is herein noted that the normal mode is a state in which the attention calling signal is not outputted, meaning a faultless mode in which neither failure nor misuse is occurring.

In step S4, the attention calling signal is outputted. That is, even when the call signal is issued and in conversation, the call by the call signal is stopped when a failure or the like has occurred, and the attention calling state is displayed on the monitor screen 22 by the attention calling signal. In this case, since an anomaly or the like is occurring, the operation of the hot water supply device is subsequently stopped (ended), and a measure (e.g., to repair the anomaly part) is to be carried out. When the call is to be interrupted partway, it is preferable to give notice of the interruption in advance by a sound or monitor display.

In step S5, the call signal is preferentially outputted. In this case, since neither failure nor the like is occurring, the conversation is prevented from being interrupted even if the operation signal is issued when the user taking a bath is conversing with a user in another room. The program flow proceeds from step S5 to step S6 to determine whether or not the call signal has exceeded a prescribed set time.

When the call signal exceeds the prescribed set time in step S6, the program flow proceeds to step S7 to display the operating condition. That is, when the call signal exceeds the prescribed set time, the conversation has contents that are not important. Therefore, the call is stopped, and the operating conditions that the user needs to know are displayed.

Moreover, when the call signal does not exceed the prescribed set time in step S6, the call is continued without interruption and thereafter ended.

In the above hot water supply device, the call signal of the interphone function is prioritized over the operation signal of the operating manipulation in the normal mode, and therefore, the call is not interrupted during the call. Therefore, communications between the user who is taking a bath or the like and the user in another room or the like can stably be achieved. In addition, the operation signal is transmitted when the call ends, allowing the various operations of the additional boiling operation to pour some more hot water into the bathtub and so on to be performed.

At the time of the occurrence of an anomaly or in another case, the user can be informed of the attention calling state by the attention calling function. In addition, the attention calling signal is prioritized over the call signal in the attention calling mode in which the attention calling signal is outputted, and therefore, the user can securely grasp the attention calling state. This can avoid the operation performed still in the anomaly state without perceiving the occurrence of the anomaly that is actually occurring. That is, the operation is not performed in the anomaly state, and the occurrence of the failure of the hot water supply device can be prevented.

Moreover, since the operating condition display function to display the operating conditions is provided, the user can grasp the operating conditions. The operating conditions mean the conditions of the remaining amount of usable high temperature hot water (hot water remaining amount) in the hot water reservoir tank and so on, and the operating conditions include those which the user needs to periodically know. Therefore, the hot water supply device is able to stop the call signal and display the operating conditions when the call signal exceeds the prescribed set time. That is, it is often the case where a conversation continuation state takes place due to an erroneous call signal ascribed to ambient noises or the conversation has contents that are not important when the call signal exceeds the prescribed set time. Therefore, the call is stopped, and the operating conditions that the user needs to know are displayed, improving the usability of the hot water supply device.

The present hot water supply device is able to stop the transmission and reception of the call signal while the operation signal is transmitted by the switch manipulation of the bath remote controller. That is, it is enabled to transmit the operation signal concerning the operation performed by manipulating the switch 21 of the bath remote controller 20 (the signal concerning the operation which is a bath setting temperature changing signal or a command signal for changing the hot water supply temperature, for additionally boiling water to replenish the hot water reservoir tank with high temperature hot water or the like) can be transmitted preferentially over the call signal. This prevents the call signal from interrupting and stopping the operating manipulation while the manipulating operation is performed, so that the operation change demanded by the user can reliably be performed.

The attention calling function section 20a, which has been provided for the bath remote controller 20 in the above embodiment, may be provided for the host remote controller.

Moreover, the operating condition display function part 20b, which has been provided for the host remote controller 27 and the bath remote controller 20 in the above embodiment, may be provided for one of the host remote controller and the bath remote controller.

Although the concrete embodiment of the present invention has been described above, the present invention is not limited to the above embodiment but allowed to be implemented through a variety of changes within the scope of the present invention. For example, although the hot water supply device has been the heat pump type water heater employing the heat pump unit as the heat source in the above embodiment, it may be one that employs another electric heater or the like as the heat source. Moreover, it may be one that has no hot water reservoir tank. Furthermore, the prescribed set time in step S6 of FIG. 3 can arbitrarily be set. Moreover, it is acceptable to place a slave remote controller in a bedroom, a child's room and the like and to enable a call between the slave remote controller and the host remote controller, a call between the slave remote controller and the bath remote controller and a call between slave remote controllers.

1. A hot water supply device comprising:
a host remote controller (27) having an interphone function section (27a); and
a remote controller (20) having an interphone function section (25) capable of establishing a call with the interphone function section (27a) of the host remote controller (27), wherein
a call signal between the interphone function section (27a) of the host remote controller (27) and the interphone function section (25) of the remote controller (20) is prioritized over an operation signal by switch manipulation of the host remote controller (27) or the remote controller (20) in a normal mode, and the operation signal is transmitted after the call signal ends.

2. The hot water supply device as claimed in claim 1, wherein
the host remote controller (27) or the bath remote controller (20) has an attention calling function section (20a) that outputs an attention calling signal during an anomaly, and
the attention calling signal outputted from the attention calling function section (20a) is prioritized over the call signal.

3. The hot water supply device as claimed in claim 1, wherein
at least one of the host remote controller (27) and the remote controller (20) has an operating condition display function section (20b) that displays the operating condition, and,
when the call signal exceeds a prescribed set time, the call signal is stopped and the operating condition is displayed by the operating condition display function section (20b).

4. The hot water supply device as claimed in claim 1, wherein,
while the operation signal is transmitted by the switch manipulation of the host remote controller (27) or the remote controller (20), the interphone function section (27a) of the host remote controller (27) and the interphone function section (25) of the remote controller (20) stop transmission and reception of the call signal.
